(19) United States
(12) Patent Application Publication
(10) Pub. No.: US 2024/0389669 A1
(43) Pub. Date: Nov. 28, 2024

(54) AEROSOL-GENERATING DEVICE AND OPERATION METHOD THEREOF

(71) Applicant: KT&G CORPORATION, Daejeon (KR)

(72) Inventors: Jueon PARK, Seoul (KR); Taehun KIM, Yongin-si Gyeonggi-do (KR); Hyungjin JUNG, Seoul (KR)

(73) Assignee: KT&G CORPORATION, Daejeon (KR)

(21) Appl. No.: 18/695,287

(22) PCT Filed: Oct. 19, 2022
(86) PCT No.: PCT/KR2022/015950

§ 371 Date: Mar. 25, 2024

(30) Foreign Application Priority Data
Oct. 20, 2021 (KR) 10-2021-0140615

(51) Int. Cl. A24F 40/51; A24F 40/53; A24F 40/90; G01K 3/00; G01K 7/22; H01M 10/42; H01M 10/48; H02J 7/00

(52) U.S. Cl. CPC A24F 40/51; A24F 40/53; A24F 40/90; G01K 3/005; G01K 7/22; H01M 10/425; H01M 10/486; H01M 2220/30; H02J 7/007194

(57) ABSTRACT

An aerosol-generating device and an operation method thereof are disclosed. The aerosol-generating device of the disclosure includes a heater configured to heat an aerosol-generating substance, a battery configured to supply power to the heater, a temperature sensor disposed adjacent to the battery, and a controller. When charging of the battery is stopped, the controller monitors a value detected by the temperature sensor. When a result of monitoring the value detected by the temperature sensor satisfies a predetermined condition related to the battery, the controller determines the value detected by the temperature sensor to be a temperature of the battery. When the result of monitoring the value detected by the temperature sensor does not satisfy the predetermined condition, the controller determines a result of compensation of the value detected by the temperature sensor to be the temperature of the battery.

### TECHNICAL FIELD

The present disclosure relates to an aerosol-generating device and an operation method thereof.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE

### Technical Problem

It is an object of the present disclosure to solve the above and other problems.

It is another object of the present disclosure to provide an aerosol-generating device and an operation method thereof capable of accurately detecting the temperature of a battery using a temperature sensor disposed adjacent to the battery.

It is still another object of the present disclosure to provide an aerosol-generating device and an operation method thereof capable of stopping charging of a battery as needed depending on the temperature of the battery while charging the battery.

### Technical Solution

An aerosol-generating device according to an aspect of the present disclosure for accomplishing the above and other objects may include a heater configured to heat an aerosol-generating substance, a battery configured to supply power to the heater, a temperature sensor disposed adjacent to the battery, and a controller. When charging of the battery is stopped, the controller may monitor a value detected by the temperature sensor. When a result of monitoring the value detected by the temperature sensor satisfies a predetermined condition related to the battery, the controller may determine the value detected by the temperature sensor to be a temperature of the battery. When the result of monitoring the value detected by the temperature sensor does not satisfy the predetermined condition, the controller may determine a result of compensation of the value detected by the temperature sensor to be the temperature of the battery.

An operation method of an aerosol-generating device according to an aspect of the present disclosure for accomplishing the above and other objects may include monitoring a value detected by a temperature sensor disposed adjacent to a battery when charging of the battery is stopped, determining the value detected by the temperature sensor to be a temperature of the battery when a result of monitoring the value detected by the temperature sensor satisfies a predetermined condition related to the battery, and determining a result of compensation of the value detected by the temperature sensor to be the temperature of the battery when the result of monitoring the value detected by the temperature sensor does not satisfy the predetermined condition.

### Advantageous Effects

According to at least one of embodiments of the present disclosure, it may be possible to accurately detect the temperature of a battery using a temperature sensor disposed adjacent to the battery.

In addition, according to at least one of embodiments of the present disclosure, it may be possible to stop charging a battery as needed depending on the temperature of the battery while charging the battery, thereby increasing the safety of the battery and the reliability of the product.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### DESCRIPTION OF DRAWINGS

The above and other objects, features and other advantages of the present disclosure will be more clearly understood from the following detailed description taken in conjunction with the accompanying drawings, in which:

FIG. 1 is a block diagram of an aerosol-generating device according to an embodiment of the present disclosure;

FIGS. 2A to 4 are views for explaining the aerosol-generating device according to embodiments of the present disclosure;

FIG. 5 is a perspective view defining the directions of an aerosol-generating device according to an embodiment of the present disclosure;

FIGS. 6 and 7 are flowcharts showing an operation method of the aerosol-generating device according to an embodiment of the present disclosure; and

FIGS. 8 and 9 are views for explaining the operation of the aerosol-generating device.

### BEST MODE

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

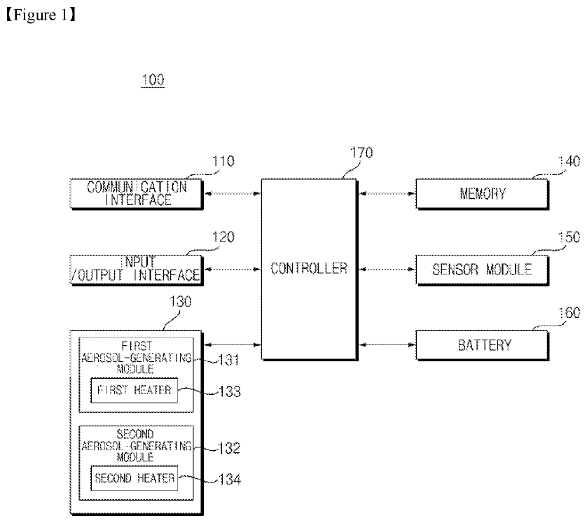

FIG. 1 is a block diagram of an aerosol-generating device according to an embodiment of the present disclosure.

Referring to FIG. 1, an aerosol-generating device 100 may include a communication interface 110, an input/output interface 120, an aerosol-generating module 130, a memory 140, a sensor module 150, a battery 160, and/or a controller 170.

In one embodiment, the aerosol-generating device 100 may be composed only of a main body. In this case, components included in the aerosol-generating device 100 may be located in the main body. In another embodiment, the aerosol-generating device 100 may be composed of a cartridge, which contains an aerosol-generating substance, and a main body. In this case, the components included in the aerosol-generating device 100 may be located in at least one of the main body or the cartridge.

The communication interface 110 may include at least one communication module for communication with an external device and/or a network. For example, the communication interface 110 may include a communication module for wired communication, such as a Universal Serial Bus (USB). For example, the communication interface 110 may include a communication module for wireless communication, such as Wireless Fidelity (Wi-Fi), Bluetooth, Bluetooth Low Energy (BLE), ZigBee, or nearfield communication (NFC).

The input/output interface 120 may include an input device for receiving a command from a user and/or an output device for outputting information to the user. For example, the input device may include a touch panel, a physical button, a microphone, or the like. For example, the output device may include a display device for outputting visual information, such as a display or a light-emitting diode (LED), an audio device for outputting auditory information, such as a speaker or a buzzer, a motor for outputting tactile information such as haptic effect, or the like.

The input/output interface 120 may transmit data corresponding to a command input by the user through the input device to another component (or other components) of the aerosol-generating device 100, and may output information corresponding to data received from another component (or other components) of the aerosol-generating device 100 through the output device.

The aerosol-generating module 130 may generate an aerosol from an aerosol-generating substance. Here, the aerosol-generating substance may be a substance in a liquid state, a solid state, or a gel state, which is capable of generating an aerosol, or a combination of two or more aerosol-generating substances.

According to an embodiment, the liquid aerosol-generating substance may be a liquid including a tobacco-containing material having a volatile tobacco flavor component. According to another embodiment, the liquid aerosol-generating substance may be a liquid including a non-tobacco material. For example, the liquid aerosol-generating substance may include water, solvents, nicotine, plant extracts, flavorings, flavoring agents, vitamin mixtures, etc.

The solid aerosol-generating substance may include a solid material based on a tobacco raw material such as a reconstituted tobacco sheet, shredded tobacco, or granulated tobacco. In addition, the solid aerosol-generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol-generating substance may further include an aerosol-forming agent such as glycerin or propylene glycol.

The aerosol-generating module 130 may include at least one heater.

The aerosol-generating module 130 may include an electro-resistive heater. For example, the electro-resistive heater may include at least one electrically conductive track, and may be heated as current flows through the electrically conductive track. At this time, the aerosol-generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may be formed in any one of a tubular shape, a plate shape, a needle shape, a rod shape, and a coil shape.

The aerosol-generating module 130 may include a heater that uses an induction-heating method. For example, the induction heater may include an electrically conductive coil, and may generate an alternating magnetic field, which periodically changes in direction, by adjusting the current flowing through the electrically conductive coil. At this time, when the alternating magnetic field is applied to a magnetic body, energy loss may occur in the magnetic body due to eddy current loss and hysteresis loss, and the lost energy may be released as thermal energy. Accordingly, the aerosol-generating substance located adjacent to the magnetic body may be heated. Here, an object that generates heat due to the magnetic field may be referred to as a susceptor.

Meanwhile, the aerosol-generating module 130 may generate ultrasonic vibrations to thereby generate an aerosol from the aerosol-generating substance.

The aerosol-generating device 100 may include a plurality of aerosol-generating modules 130. For example, the aerosol-generating device 100 may include a first aerosol-generating module 131 for generating an aerosol by vaporizing a liquid material and a second aerosol-generating module 132 for generating an aerosol by heating a cigarette. A first heater 133 included in the first aerosol-generating module 131 may be a coil heater or a mesh heater. The first aerosol-generating module 131 may be implemented in the form of a cartridge, which is provided separately from the main body of the aerosol-generating device 100. The first aerosol-generating module 131 may be referred to as a cartomizer, an atomizer, or a vaporizer. A second heater 134 included in the second aerosol-generating module 132 may be a film heater including an electrically conductive track, or may be a susceptor configured to generate heat using an induction-heating method.

The memory 140 may store programs for processing and controlling each signal in the controller 170, and may store processed data and data to be processed.

For example, the memory 140 may store applications designed for the purpose of performing various tasks that can be processed by the controller 170, and may selectively provide some of the stored applications in response to the request from the controller 170.

For example, the memory 140 may store data on the operation time of the aerosol-generating device 100, the maximum number of puffs, the current number of puffs, at least one temperature profile, and the user's inhalation pattern. Here, “puff” means inhalation by the user, and “inhalation” means the user's act of taking air or other substances into the user's oral cavity, nasal cavity, or lungs through the user's mouth or nose.

The memory 140 may include at least one of volatile memory (e.g. dynamic random access memory (DRAM), static random access memory (SRAM), or synchronous dynamic random access memory (SDRAM)), nonvolatile memory (e.g. flash memory), a hard disk drive (HDD), or a solid-state drive (SSD).

The sensor module 150 may include at least one sensor.

For example, the sensor module 150 may include a sensor for sensing a puff (hereinafter referred to as a “puff sensor”). In this case, the puff sensor may be implemented as a pressure sensor.

For example, the sensor module 150 may include a sensor for sensing the temperature of the heater included in the aerosol-generating module 130 and the temperature of the aerosol-generating substance (hereinafter referred to as a “temperature sensor”). In this case, the heater included in the aerosol-generating module 130 may also serve as the temperature sensor. For example, the electro-resistive material of the heater may be a material having a predetermined temperature coefficient of resistance. The sensor module 150 may measure the resistance of the heater, which varies according to the temperature, to thereby sense the temperature of the heater.

For example, in the case in which the main body of the aerosol-generating device 100 is formed to allow a cigarette to be inserted thereinto, the sensor module 150 may include a sensor for sensing insertion of the cigarette (hereinafter referred to as a “cigarette detection sensor”).

For example, in the case in which the aerosol-generating device 100 includes a cartridge, the sensor module 150 may include a sensor for sensing mounting/demounting of the cartridge and the position of the cartridge (hereinafter referred to as a “cartridge detection sensor”).

In this case, the cigarette detection sensor and/or the cartridge detection sensor may be implemented as an inductance-based sensor, a capacitive sensor, a resistance sensor, or a Hall sensor (or Hall IC) using a Hall effect.

For example, the sensor module 150 may include a voltage sensor for sensing a voltage applied to a component (e.g. the battery 160) provided in the aerosol-generating device 100 and/or a current sensor for sensing a current.

The battery 160 may supply electric power used for the operation of the aerosol-generating device 100 under the control of the controller 170. The battery 160 may supply electric power to other components provided in the aerosol-generating device 100, for example, the communication module included in the communication interface 110, the output device included in the input/output interface 120, and the heater included in the aerosol-generating module 130.

The battery 160 may be a rechargeable battery or a disposable battery. For example, the battery 160 may be a lithium-ion (Li-ion) battery or a lithium polymer (Li-polymer) battery. However, the present disclosure is not limited thereto. For example, when the battery 160 is rechargeable, the charging rate (C-rate) of the battery 160 may be 10 C, and the discharging rate (C-rate) thereof may be 10 C to 20 C. However, the present disclosure is not limited thereto. Also, for stable use, the battery 160 may be manufactured such that 80% or more of the total capacity may be ensured even when charging/discharging is performed 2000 times.

The aerosol-generating device 100 may further include a battery protection circuit module (PCM) (not shown), which is a circuit for protecting the battery 160. The battery protection circuit module (PCM) may be disposed adjacent to the upper surface of the battery 160. For example, in order to prevent overcharging and overdischarging of the battery 160, the battery protection circuit module (PCM) may cut off the electrical path to the battery 160 when a short circuit occurs in a circuit connected to the battery 160, when an overvoltage is applied to the battery 160, or when an overcurrent flows through the battery 160.

The aerosol-generating device 100 may further include a power terminal (not shown) to which electric power supplied from the outside is input. For example, a power line may be connected to the power terminal, which is disposed at one side of the main body of the aerosol-generating device 100, and the aerosol-generating device 100 may use the electric power supplied through the power line connected to the power terminal to charge the battery 160. In this case, the power terminal may be a wired terminal for USB communication.

The aerosol-generating device 100 may wirelessly receive electric power supplied from the outside through the communication interface 110. For example, the aerosol-generating device 100 may wirelessly receive electric power using an antenna included in the communication module for wireless communication, and may charge the battery 160 using the wirelessly supplied electric power.

The controller 170 may control the overall operation of the aerosol-generating device 100. The controller 170 may be connected to each of the components provided in the aerosol-generating device 100, and may transmit and/or receive a signal to and/or from each of the components, thereby controlling the overall operation of each of the components.

The controller 170 may include at least one processor, and may control the overall operation of the aerosol-generating device 100 using the processor included therein. Here, the processor may be a general processor such as a central processing unit (CPU). Of course, the processor may be a dedicated device such as an application-specific integrated circuit (ASIC), or may be any of other hardware-based processors.

The controller 170 may perform any one of a plurality of functions of the aerosol-generating device 100. For example, the controller 170 may perform any one of a plurality of functions of the aerosol-generating device 100 (e.g. a preheating function, a heating function, a charging function, and a cleaning function) according to the state of each of the components provided in the aerosol-generating device 100 and the user's command received through the input/output interface 120.

The controller 170 may control the operation of each of the components provided in the aerosol-generating device 100 based on data stored in the memory 140. For example, the controller 170 may control the supply of a predetermined amount of electric power from the battery 160 to the aerosol-generating module 130 based on the data on the temperature profile and the user's inhalation pattern, which is stored in the memory 140.

The controller 170 may determine the occurrence or non-occurrence of a puff using the puff sensor included in the sensor module 150. For example, the controller 170 may check a temperature change, a flow change, a pressure change, and a voltage change in the aerosol-generating device 100 based on the values sensed by the puff sensor, and may determine the occurrence or non-occurrence of a puff based on the result of the checking.

The controller 170 may control the operation of each of the components provided in the aerosol-generating device 100 according to the occurrence or non-occurrence of a puff and/or the number of puffs. For example, upon determining that a puff has occurred, the controller 170 may perform control such that a predetermined amount of electric power is supplied to the heater according to the temperature profile stored in the memory 140. For example, the controller 170 may perform control such that the temperature of the heater is changed or maintained based on the temperature profile stored in the memory 140.

The controller 170 may perform control such that the supply of electric power to the heater is interrupted according to a predetermined condition. For example, the controller 170 may perform control such that the supply of electric power to the heater is interrupted when the cigarette is removed, when the cartridge is demounted, when the number of puffs reaches the predetermined maximum number of puffs, when a puff is not sensed during a predetermined period of time or longer, or when the remaining capacity of the battery 160 is less than a predetermined value.

The controller 170 may calculate the remaining capacity with respect to the full charge capacity of the battery 160. For example, the controller 170 may calculate the remaining capacity of the battery 160 based on the values sensed by the voltage sensor and/or the current sensor included in the sensor module 150.

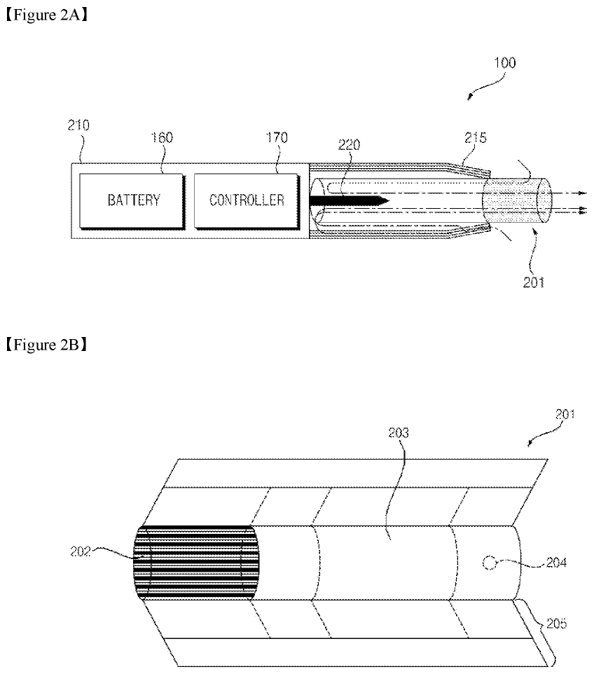

FIGS. 2A to 4 are views for explaining the aerosol-generating device according to embodiments of the present disclosure.

According to various embodiments of the present disclosure, the aerosol-generating device 100 may include a main body and/or a cartridge.

Referring to FIG. 2A, the aerosol-generating device 100 according to an embodiment may include a main body 210, which is formed such that a cigarette 201 can be inserted into the inner space formed by a housing 215.

The cigarette 201 may be similar to a general combustive cigarette. For example, the cigarette 201 may be divided into a first portion including an aerosol-generating substance and a second portion including a filter. Alternatively, the second portion of the cigarette 201 may also include an aerosol-generating substance. For example, a granular or capsular flavoring material may be inserted into the second portion.

The entirety of the first portion may be inserted into the aerosol-generating device 100, and the second portion may be exposed to the outside. Alternatively, only a portion of the first portion may be inserted into the aerosol-generating device 100. Alternatively, the entirety of the first portion and a portion of the second portion may be inserted into the aerosol-generating device 100. The user may inhale the aerosol in the state of holding the second portion in the mouth. At this time, the aerosol may be generated as external air passes through the first portion, and the generated aerosol may pass through the second portion to be introduced into the mouth of the user.

The main body 210 may be structured such that external air is introduced into the main body 210 in the state in which the cigarette 201 is inserted thereinto. In this case, the external air introduced into the main body 210 may flow into the mouth of the user via the cigarette 201.

When the cigarette 201 is inserted, the controller 170 may perform control such that electric power is supplied to the heater based on the temperature profile stored in the memory 140.

The controller 170 may perform control such that electric power is supplied to the heater using at least one of a pulse width modulation (PWM) method or a proportional-integral-differential (PID) method.

For example, the controller 170 may perform control such that a current pulse having a predetermined frequency and a predetermined duty ratio is supplied to the heater using the PWM method. In this case, the controller 170 may control the amount of electric power supplied to the heater by adjusting the frequency and the duty ratio of the current pulse.

For example, the controller 170 may determine a target temperature to be controlled based on the temperature profile. In this case, the controller 170 may control the amount of electric power supplied to the heater using the PID method, which is a feedback control method using a difference value between the temperature of the heater and the target temperature, a value obtained by integrating the difference value with respect to time, and a value obtained by differentiating the difference value with respect to time.

Although the PWM method and the PID method are described as examples of methods of controlling the supply of electric power to the heater, the present disclosure is not limited thereto, and may employ any of various control methods, such as a proportional-integral (PI) method or a proportional-differential (PD) method.

The heater may be disposed in the main body 210 at a position corresponding to the position at which the cigarette 201 is inserted into the main body 210. Although it is illustrated in the drawings that the heater is an electrically conductive heater 220 including a needle-shaped electrically conductive track, the present disclosure is not limited thereto.

The heater may heat the interior and/or exterior of the cigarette 201 using the electric power supplied from the battery 160, and an aerosol may be generated from the heated cigarette 201. At this time, the user may hold one end of the cigarette 201 in the mouth to inhale the aerosol containing a tobacco material.

Meanwhile, the controller 170 may perform control such that electric power is supplied to the heater in the state in which the cigarette 201 is not inserted into the main body according to a predetermined condition. For example, when a cleaning function for cleaning the space into which the cigarette 201 is inserted is selected in response to a command input by the user through the input/output interface 120, the controller 170 may perform control such that a predetermined amount of electric power is supplied to the heater.

The controller 170 may monitor the number of puffs based on the value sensed by the puff sensor from the time point at which the cigarette 201 was inserted into the main body.

When the cigarette 201 is removed from the main body, the controller 170 may initialize the current number of puffs stored in the memory 140.

Referring to FIG. 2B, the cigarette 201 according to an embodiment may include a tobacco rod 202 and a filter rod 203. The first portion described above with reference to FIG. 2A may include the tobacco rod 202, and the second portion may include the filter rod 203.

Although it is illustrated in FIG. 2B that the filter rod 203 is composed of a single segment, the present disclosure is not limited thereto. In other words, the filter rod 203 may be composed of a plurality of segments. For example, the filter rod 203 may include a first segment configured to cool an aerosol and a second segment configured to remove a predetermined component included in the aerosol. In addition, the filter rod 203 may further include at least one segment configured to perform other functions, as needed.

The cigarette 201 may be packed using at least one wrapper 205. The wrapper 205 may have at least one hole formed therein to allow external air to be introduced thereinto or to allow internal gas to be discharged therefrom. In one example, the cigarette 201 may be packed using one wrapper 205. In another example, the cigarette 201 may be doubly packed using two or more wrappers 205. For example, the tobacco rod 202 may be packed using a first wrapper, and the filter rod 203 may be packed using a second wrapper. Also, the tobacco rod 202 and the filter rod 203, which are individually packed using separate wrappers, may be coupled to each other, and the entire cigarette 201 may be packed using a third wrapper. When each of the tobacco rod 202 and the filter rod 203 is composed of a plurality of segments, each segment may be packed using a separate wrapper. Also, the entire cigarette 201, formed by coupling segments, each of which is packed using a separate wrapper, to each other, may be packed using another wrapper.

The tobacco rod 202 may include an aerosol-generating substance. For example, the aerosol-generating substance may include at least one of glycerin, propylene glycol, ethylene glycol, dipropylene glycol, diethylene glycol, triethylene glycol, tetraethylene glycol, or oleyl alcohol, but the present disclosure is not limited thereto. Also, the tobacco rod 202 may include other additives, such as a flavoring agent, a wetting agent, and/or an organic acid. Also, a flavoring liquid, such as menthol or a moisturizer, may be injected into and added to the tobacco rod 202.

The tobacco rod 202 may be manufactured in various forms. For example, the tobacco rod 202 may be formed as a sheet or a strand. Also, the tobacco rod 202 may be formed as shredded tobacco, which is formed by cutting a tobacco sheet into tiny bits. Also, the tobacco rod 202 may be surrounded by a thermally conductive material. For example, the thermally conductive material may be a metal foil such as aluminum foil, but the present disclosure is not limited thereto. In one example, the thermally conductive material surrounding the tobacco rod 202 may uniformly distribute heat transmitted to the tobacco rod 202, thereby improving conduction of the heat applied to the tobacco rod and thus improving the taste of the tobacco. Also, the thermally conductive material surrounding the tobacco rod 202 may function as a susceptor that is heated by the induction heater. Here, although not illustrated in the drawings, the tobacco rod 202 may further include an additional susceptor, in addition to the thermally conductive material surrounding the tobacco rod 202.

The filter rod 203 may be a cellulose acetate filter. The filter rod 203 may be formed in any of various shapes. For example, the filter rod 203 may be a cylinder-type rod or a hollow tube-type rod. Also, the filter rod 203 may be a recess-type rod. When the filter rod 203 is composed of a plurality of segments, at least one of the plurality of segments may be formed in a different shape.

The filter rod 203 may be formed to generate flavors. In one example, a flavoring liquid may be injected into the filter rod 203, or a separate fiber coated with a flavoring liquid may be inserted into the filter rod 203.

In addition, the filter rod 203 may include at least one capsule 204. Here, the capsule 204 may function to generate a flavor, or may function to generate an aerosol. For example, the capsule 204 may have a structure in which a liquid containing a flavoring material is wrapped with a film. The capsule 204 may have a spherical or cylindrical shape, but the present disclosure is not limited thereto.

When the filter rod 203 includes a segment configured to cool the aerosol, the cooling segment may be made of a polymer material or a biodegradable polymer material. For example, the cooling segment may be made of pure polylactic acid alone, but the present disclosure is not limited thereto. Alternatively, the cooling segment may be formed as a cellulose acetate filter having a plurality of holes formed therein. However, the cooling segment is not limited to the above-described example, and any other type of cooling segment may be used, so long as the same is capable of cooling the aerosol.

Although not illustrated in FIG. 2B, the cigarette 201 according to an embodiment may further include a front-end filter. The front-end filter may be located at the side of the tobacco rod 202 that faces the filter rod 203. The front-end filter may prevent the tobacco rod 202 from becoming detached outwards, and may prevent a liquefied aerosol from flowing into the aerosol-generating device 100 from the tobacco rod 202 during inhalation by the user.

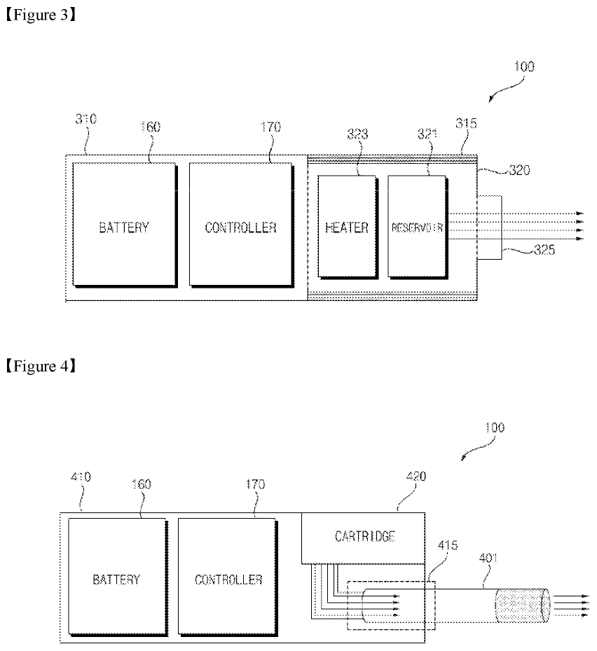

Referring to FIG. 3, the aerosol-generating device 100 according to an embodiment may include a main body 310 and a cartridge 320. The main body 310 may support the cartridge 320, and the cartridge 320 may contain an aerosol-generating substance.

According to one embodiment, the cartridge 320 may be configured so as to be detachably mounted to the main body 310. According to another embodiment, the cartridge 320 may be formed integrally with the main body 310. For example, the cartridge 320 may be mounted to the main body 310 in a manner such that at least a portion of the cartridge 320 is inserted into the inner space formed by a housing 315 of the main body 310.

The main body 310 may be formed to have a structure in which external air can be introduced into the main body 310 in the state in which the cartridge 320 is inserted thereinto. Here, the external air introduced into the main body 310 may flow into the user's mouth via the cartridge 320.

The controller 170 may determine whether the cartridge 320 is in a mounted state or a detached state using a cartridge detection sensor included in the sensor module 150. For example, the cartridge detection sensor may transmit a pulse current through a terminal connected to the cartridge, and may determine whether the pulse current is received through another terminal, thereby detecting whether the cartridge is in a connected state.

The cartridge 320 may include a reservoir 321 configured to contain the aerosol-generating substance and/or a heater 323 configured to heat the aerosol-generating substance in the reservoir 321. For example, a liquid delivery element impregnated with (containing) the aerosol-generating substance may be disposed inside the reservoir 321, and the electrically conductive track of the heater 323 may be formed in a structure that is wound around the liquid delivery element. In this case, when the liquid delivery element is heated by the heater 323, an aerosol may be generated. Here, the liquid delivery element may include a wick made of, for example, cotton fiber, ceramic fiber, glass fiber, or porous ceramic.

The cartridge 320 may include a mouthpiece 325. Here, the mouthpiece 325 may be a portion to be inserted into a user's oral cavity, and may have a discharge hole through which the aerosol is discharged to the outside during a puff.

Referring to FIG. 4, the aerosol-generating device 100 according to an embodiment may include a main body 410 and a cartridge 420. The main body 410 may be formed so as to support the cartridge 420 and to allow a cigarette 401 to be inserted into an inner space 415 therein, and the cartridge 420 may contain an aerosol-generating substance.

The aerosol-generating device 100 may include a first heater for heating the aerosol-generating substance stored in the cartridge 420. For example, when the user holds one end of the cigarette 401 in the mouth to inhale the aerosol, the aerosol generated by the first heater may pass through the cigarette 401. At this time, while the aerosol passes through the cigarette 401, a tobacco material may be added to the aerosol, and the aerosol containing the tobacco material may be drawn into the user's oral cavity through one end of the cigarette 401.

Alternatively, according to another embodiment, the aerosol-generating device 100 may include a first heater for heating the aerosol-generating substance stored in the cartridge 420 and a second heater for heating the cigarette 401 inserted into the main body 410. For example, the aerosol-generating device 100 may generate an aerosol by heating the aerosol-generating substance stored in the cartridge 420 and the cigarette 401 using the first heater and the second heater, respectively.

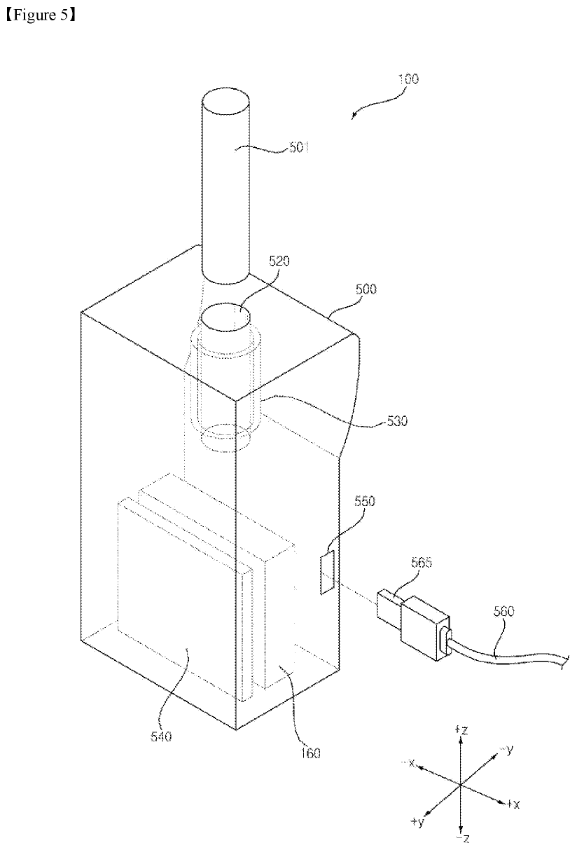

FIG. 5 is a perspective view defining the directions of an aerosol-generating device according to an embodiment of the present disclosure.

In the orthogonal coordinate system, the x-axis direction may be defined as the leftward-rightward direction of the aerosol-generating device 100. Here, based on the origin, the +x-axis direction may be the rightward direction, and the −x-axis direction may be the leftward direction. The y-axis direction may be defined as the forward-backward direction of the aerosol-generating device 100. Here, based on the origin, the +y-axis direction may be the forward direction, and the −y-axis direction may be the backward direction. The z-axis direction may be defined as the upward-downward direction of the aerosol-generating device 100. Here, based on the origin, the +z-axis direction may be the upward direction, and the −z-axis direction may be the downward direction.

Referring to FIG. 5, an insertion space 520, into which a cigarette 501 is inserted, may be defined in the upper end of a housing 500 of the aerosol-generating device 100.

The insertion space 520 may be formed so as to be depressed to a predetermined depth toward the interior of the housing 500 so that the cigarette 501 is inserted at least partway thereinto. The depth of the insertion space 520 may correspond to the length of the portion of the cigarette 501 that contains an aerosol-generating substance. For example, in the case in which the cigarette 201 shown in FIG. 2B is capable of being used in the aerosol-generating device 100, the depth of the insertion space 520 may correspond to the length of a tobacco rod 202 of the cigarette 201.

A battery 160, a heater 530, and a printed circuit board 540 may be disposed in the housing 500 of the aerosol-generating device 100.

The heater 530 may be disposed adjacent to the insertion space 520. The heater 530 may heat the cigarette 501 located in the insertion space 520 using power supplied from the battery 160.

The components of the aerosol-generating device 100 may be mounted on one surface and/or the opposite surface of the printed circuit board 540. The components mounted on the printed circuit board 540 may transmit or receive signals therebetween through a wiring layer of the printed circuit board 540.

The printed circuit board 540 may be disposed adjacent to the battery 160. For example, the printed circuit board 540 may be disposed such that one surface thereof faces the battery 160.

A temperature sensor may be mounted on one surface of the printed circuit board 540. The temperature sensor may be implemented as a thermistor, which is characterized in that the resistance thereof changes with temperature. For example, the temperature sensor may include a negative temperature coefficient (NTC) thermistor, which is characterized in that the resistance thereof decreases when temperature rises.

The controller 170 may be mounted on the printed circuit board 540. The controller 170 may monitor the value detected by the temperature sensor. For example, the controller 170 may monitor the detected value corresponding to the resistance value of the thermistor constituting the temperature sensor.

The controller 170 may determine the temperature of the battery 160 based on the value detected by the temperature sensor. For example, the controller 170 may determine the value detected by the temperature sensor to be the temperature of the battery 160. For example, the controller 170 may determine the result of compensating for the value detected by the temperature sensor according to a predetermined criterion to be the temperature of the battery 160.

A power terminal 550 may be disposed on one side of the housing 500 of the aerosol-generating device 100. The power terminal 550 may be a wired terminal for wired communication such as USB.

A power supply circuit (not shown) may be disposed between the battery 160 and the power terminal 550. The power supply circuit may transmit power supplied from the outside through the power terminal 550 to the battery 160.

A power line 560 for supplying power may be connected to the power terminal 550. For example, the power terminal 550 may be coupled to a connector 565 of the power line 560.

The controller 170 may determine whether the power line 560 is connected to the power terminal 550. For example, the controller 170 may determine whether the power line 560 is connected to the power terminal 550 based on a signal generated in response to connection of the power line 560 to the power terminal 550.

When the power line 560 is connected to the power terminal 550, the controller 170 may initiate charging of the battery 160. When the power line 560 is connected to the power terminal 550, the controller 170 may control operation of the components of the aerosol-generating device 100 so that power supplied through the power line 560 is transmitted to the battery 160. For example, when the power line 560 is connected to the power terminal 550 in the state in which the cigarette 501 is inserted into the housing 500, the controller 170 may interrupt the supply of power to the aerosol-generating module 130, and may initiate charging of the battery 160.

The structure of the aerosol-generating device 100 is not limited to the structure shown in FIG. 5. In some embodiments, the arrangement of the battery 160, the insertion space 510, the heater 530, and the power terminal 550 may vary.

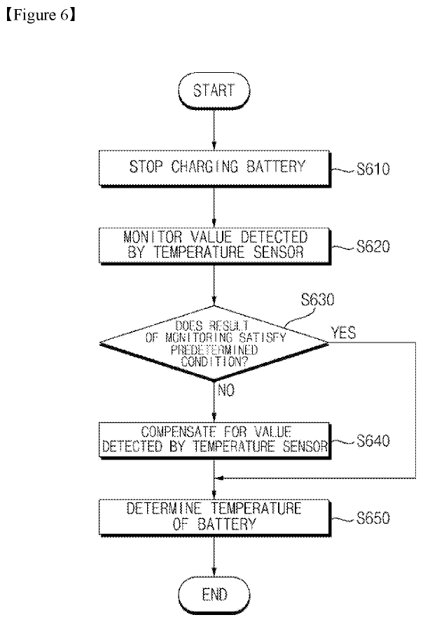

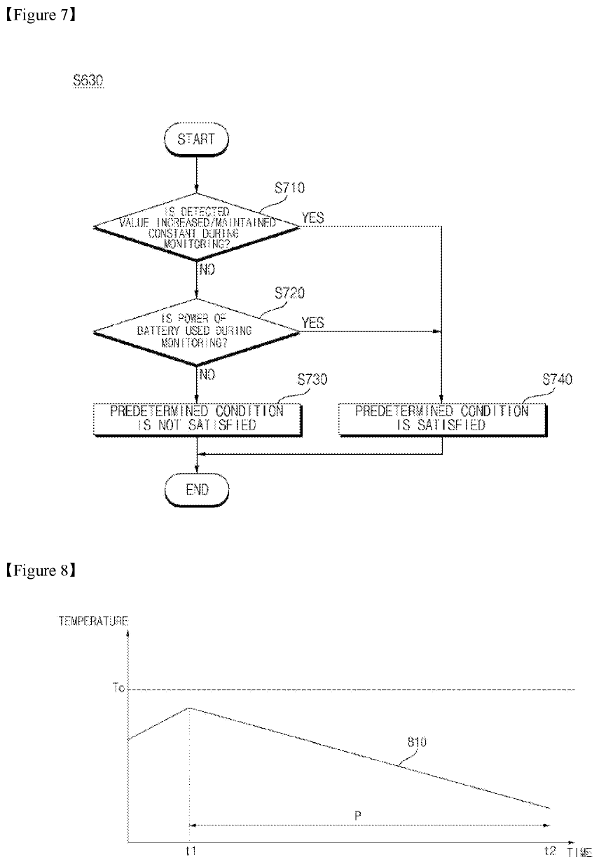

FIGS. 6 and 7 are flowcharts showing an operation method of an aerosol-generating device according to an embodiment of the present disclosure.

Referring to FIG. 6, the aerosol-generating device 100 may stop charging the battery 160 in operation S610. For example, the aerosol-generating device 100 may stop charging the battery 160 when the power line 560 is separated from the power terminal 550.

The aerosol-generating device 100 may monitor the value detected by the temperature sensor, which is disposed adjacent to the battery 160, in operation S620. For example, the controller 170 may monitor the detected value corresponding to the resistance value of the thermistor constituting the temperature sensor.

The aerosol-generating device 100 may determine whether the result of monitoring the value detected by the temperature sensor satisfies a predetermined condition related to the battery 160 in operation S630. Here, the predetermined condition related to the battery 160 may correspond to a factor influencing the change in the value detected by the temperature sensor.

While the battery 160 is being charged, the temperature of the battery 160 may increase due to a reaction of an electrolyte in the battery 160. In addition, when the temperature of the battery 160 increases, the ambient temperature of the battery 160 may also increase, which may lead to a change in the value detected by the temperature sensor. In the case in which the temperature sensor is spaced a predetermined distance apart from the battery 160, rather than being in contact therewith, a difference may occur between the temperature of the battery 160 and the value detected by the temperature sensor. For example, while the battery 160 is being charged, the value detected by the temperature sensor may be higher than the temperature of the battery 160 by a predetermined temperature due to not only heat generated from the battery 160 but also heat generated from other components, such as a processor of the controller 170.

Meanwhile, when the value detected by the temperature sensor changes for a reason other than charging of the battery 160, the temperature of the battery 160 and the value detected by the temperature sensor may be the same as or similar to each other. For example, when the cigarette 501 is heated by the heater 530, or when the ambient temperature of the aerosol-generating device 100 changes, the battery 160 and the temperature sensor may be equally influenced by the change in temperature, and thus the difference between the temperature of the battery 160 and the value detected by the temperature sensor may decrease below a predetermined level.

According to an embodiment of the present disclosure, upon receiving a request for initiating charging of the battery 160 after stop of charging of the battery 160, the aerosol-generating device 100 may determine whether to initiate charging of the battery 160 based on the temperature of the battery 160. For example, when the power line 560 is connected to the power terminal 550, the aerosol-generating device 100 may determine that a request for initiating charging of the battery 160 has been made.

A determination as to whether a predetermined condition related to the battery 160 is satisfied will be described with reference to FIG. 7.

Referring to FIG. 7, while monitoring the value detected by the temperature sensor, the aerosol-generating device 100 may determine whether a period during which the value detected by the temperature sensor increases and/or a period during which the value detected by the temperature sensor is maintained constant is being monitored in operation S710. For example, the aerosol-generating device 100 may determine whether a period during which the value detected by the temperature sensor increases and/or a period during which the value detected by the temperature sensor is maintained constant is included in at least part of a period corresponding to the entire time during which the value detected by the temperature sensor is monitored (hereinafter referred to as an “entire period”).

Referring to the graph 810 shown in FIG. 8, which indicates the value detected by the temperature sensor, the value detected by the temperature sensor may increase until a time point t1 at which charging of the battery 160 ends. That is, while the battery 160 is being charged, the ambient temperature of the temperature sensor may increase due to heat generated from the battery 160.

Meanwhile, when there is no factor, other than the temperature of the battery 160, that influences the change in the value detected by the temperature sensor, the value detected by the temperature sensor may decrease in the entire period P corresponding to a time period from the time point t1 at which charging of the battery 160 ends to the time point t2. For example, the value detected by the temperature sensor may decrease to a temperature equivalent to the ambient temperature of the aerosol-generating device 100 from the time point t1 at which charging of the battery 160 ends. In this case, similar to the value detected by the temperature sensor, the temperature of the battery 160 may also decrease over time.

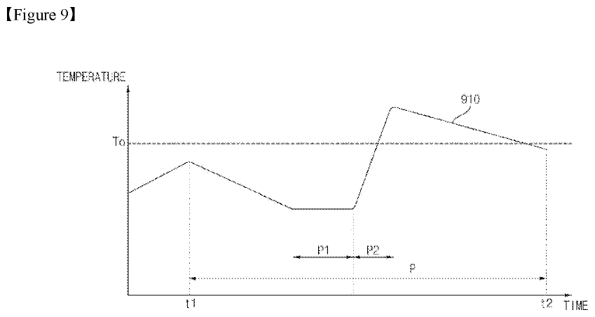

Meanwhile, referring to the graph 910 shown in FIG. 9, which indicates the value detected by the temperature sensor, the value detected by the temperature sensor may increase until the time point t1 at which charging of the battery 160 ends in a manner similar to that indicated by the graph 810 shown in FIG. 8. In addition, the value detected by the temperature sensor may decrease from the time point t1 at which charging of the battery 160 ends.

A period P1 during which the value detected by the temperature sensor is maintained constant and/or a period P2 during which the value detected by the temperature sensor increases may be included in the entire period P corresponding to the time period from the time point t1 to the time point t2. For example, when the value detected by the temperature sensor reaches a temperature equivalent to the ambient temperature of the aerosol-generating device 100, the value detected by the temperature sensor may be maintained constant. For example, when the aerosol-generating device 100 heats the cigarette 501 using the heater 530, the value detected by the temperature sensor may increase. For example, when the cigarette 501 is completely heated, the value detected by the temperature sensor may decrease again.

While monitoring the value detected by the temperature sensor, the aerosol-generating device 100 may determine whether a period during which the power of the battery 160 is used is being monitored in operation S720. For example, the aerosol-generating device 100 may determine whether the period during which the power of the battery 160 is used is included in at least part of the entire period during which the value detected by the temperature sensor is monitored.

While monitoring the value detected by the temperature sensor, the aerosol-generating device 100 may monitor the period during which the power of the battery 160 is used depending on whether the aerosol-generating device 100 is powered on. In this case, when the aerosol-generating device 100 is powered on, the processor of the controller 170 operates, and accordingly, heat may be generated from components other than the battery 160. In addition, the heat generated from components other than the battery 160 may influence the change in the value detected by the temperature sensor.

When none of the period during which the value detected by the temperature sensor increases, the period during which the value detected by the temperature sensor is maintained constant, and the period during which the power of the battery 160 is used is monitored, the aerosol-generating device 100 may determine that the predetermined condition related to the battery 160 is not satisfied in operation S730.

When the predetermined condition related to the battery 160 is not satisfied, the aerosol-generating device 100 may determine that there is no factor, other than the temperature of the battery 160, that influences the change in the value detected by the temperature sensor. In this case, the aerosol-generating device 100 may determine that the difference between the temperature of the battery 160 and the value detected by the temperature sensor is maintained constant in the entire period.

Meanwhile, when at least one of the period during which the value detected by the temperature sensor increases, the period during which the value detected by the temperature sensor is maintain constant, or the period during which the power of the battery 160 is used is monitored, the aerosol-generating device 100 may determine that the predetermined condition related to the battery 160 is satisfied in operation S740.

When the predetermined condition related to the battery 160 is satisfied, the aerosol-generating device 100 may determine that there is a factor, in addition to the temperature of the battery 160, that influences the change in the value detected by the temperature sensor. In this case, the aerosol-generating device 100 may determine that the difference between the temperature of the battery 160 and the value detected by the temperature sensor decreases below a predetermined level in the entire period.

Referring back to FIG. 6, when the predetermined condition related to the battery 160 is not satisfied, the aerosol-generating device 100 may compensate for the value detected by the temperature sensor according to a predetermined criterion in operation S640. The aerosol-generating device 100 may determine a value obtained by subtracting a predetermined compensation value (e.g. 5° C.) from the value detected by the temperature sensor to be a result of compensation of the value detected by the temperature sensor.

The aerosol-generating device 100 may determine the temperature of the battery 160 in operation S650.

When the predetermined condition related to the battery 160 is satisfied, the aerosol-generating device 100 may determine the value detected by the temperature sensor to be the temperature of the battery 160. Meanwhile, when the predetermined condition related to the battery 160 is not satisfied, the aerosol-generating device 100 may determine the result of compensation of the value detected by the temperature sensor to be the temperature of the battery 160.

Meanwhile, the aerosol-generating device 100 may determine whether to charge the battery 160 depending on the temperature of the battery 160. When determining whether to charge the battery 160, the aerosol-generating device 100 may determine the value detected by the temperature sensor or the result of compensation of the value detected by the temperature sensor to be the temperature of the battery 160.

According to an embodiment, when the power line 560 is connected to the power terminal 550, the aerosol-generating device 100 may determine whether the temperature of the battery 160 is within a temperature range predetermined in relation to charging of the battery 160 (hereinafter referred to as a “first temperature range”). Upon determining that the temperature of the battery 160 is not within the first temperature range, the aerosol-generating device 100 may stop charging the battery 160. For example, referring to FIGS. 8 and 9, while the battery 160 is being charged, when the value detected by the temperature sensor is equal to or greater than a value TO, which corresponds to the highest temperature in the first temperature range, the aerosol-generating device 100 may stop charging the battery 160.

Meanwhile, the aerosol-generating device 100 may determine whether to use the power stored in the battery 160 depending on the temperature of the battery 160. When determining whether to use the power stored in the battery 160, the aerosol-generating device 100 may determine the value detected by the temperature sensor to be the temperature of the battery 160.

According to an embodiment, in the state in which the aerosol-generating device 100 is powered on, the aerosol-generating device 100 may determine whether the temperature of the battery 160 is within a temperature range predetermined in relation to discharging of the battery 160 (hereinafter referred to as a “second temperature range”). Upon determining that the temperature of the battery 160 is not within the second temperature range, for example, when the temperature of the battery 160 is equal to or higher than the highest temperature in the second temperature range, the aerosol-generating device 100 may stop using the power stored in the battery 160. Here, the highest temperature in the second temperature range may be higher than the highest temperature in the first temperature range.

As described above, according to at least one of the embodiments of the present disclosure, it may be possible to accurately detect the temperature of the battery 160 using the temperature sensor disposed adjacent to the battery 160.

In addition, according to at least one of the embodiments of the present disclosure, it may be possible to stop charging the battery 160 as needed depending on the temperature of the battery 160 while charging the battery 160, thereby increasing the safety of the battery 160 and the reliability of the product.

Referring to FIGS. 1 to 9, an aerosol-generating device 100 in accordance with one aspect of the present disclosure may include heaters 133 and 134 configured to heat an aerosol-generating substance, a battery 160 configured to supply power to the heaters 133 and 134, a temperature sensor disposed adjacent to the battery 160, and a controller 170. When charging of the battery 160 is stopped, the controller 170 may monitor a value detected by the temperature sensor. When a result of monitoring the value detected by the temperature sensor satisfies a predetermined condition related to the battery 160, the controller 170 may determine the value detected by the temperature sensor to be a temperature of the battery 160. When the result of monitoring the value detected by the temperature sensor does not satisfy the predetermined condition, the controller 170 may determine a result of compensation of the value detected by the temperature sensor to be the temperature of the battery 160.

In addition, in accordance with another aspect of the present disclosure, when at least one of a first period during which the value detected by the temperature sensor increases or a second period during which the value detected by the temperature sensor is maintained constant is monitored, the controller 170 may determine that the predetermined condition is satisfied.

In addition, in accordance with another aspect of the present disclosure, when a period during which power of the battery 160 is used is monitored, the controller 170 may determine that the predetermined condition is satisfied.

In addition, in accordance with another aspect of the present disclosure, the controller 170 may determine a value obtained by subtracting a predetermined compensation value from the value detected by the temperature sensor to be the result.

In addition, in accordance with another aspect of the present disclosure, upon receiving a request for initiating charging of the battery 160, the controller 170 may determine whether to initiate charging of the battery 160 based on the determined temperature of the battery 160.

In addition, in accordance with another aspect of the present disclosure, the aerosol-generating device may further include a power terminal 550 disposed on one side of a housing 500. When a power line 560 is connected to the power terminal 550, the controller 170 may determine that the request for initiating charging of the battery 160 has been made.

In addition, in accordance with another aspect of the present disclosure, when the determined temperature of the battery 160 is equal to or higher than a predetermined first temperature, the controller 170 may stop charging the battery 160.

In addition, in accordance with another aspect of the present disclosure, when the determined temperature of the battery 160 is equal to or higher than a second temperature, higher than the first temperature, the controller 170 may interrupt supply of power to components included in the aerosol-generating device 100.

In addition, in accordance with another aspect of the present disclosure, the temperature sensor may include a thermistor mounted on a printed circuit board 540 disposed adjacent to the battery 160.

An operation method of an aerosol-generating device 100 in accordance with one aspect of the present disclosure may include monitoring a value detected by a temperature sensor disposed adjacent to a battery 160 when charging of the battery 160 is stopped, determining the value detected by the temperature sensor to be a temperature of the battery 160 when a result of monitoring the value detected by the temperature sensor satisfies a predetermined condition related to the battery 160, and determining a result of compensation of the value detected by the temperature sensor to be the temperature of the battery 160 when the result of monitoring the value detected by the temperature sensor does not satisfy the predetermined condition.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device comprising:
a heater configured to heat an aerosol-generating substance;
a battery configured to supply power to the heater to enable the heater to heat the aerosol-generating substance; a temperature sensor disposed relative to the battery; and
a controller configured to:
monitor a value of the temperature sensor, after charging of the battery has stopped;
determine the value of the temperature sensor to be a determined temperature of the battery, based on the monitored value of the temperature sensor satisfying a defined condition related to the battery; and
determine compensation of the value of the temperature sensor to be the determined temperature of the battery, based on the monitored value of the temperature sensor not satisfying the defined condition related to the battery.

2. The aerosol-generating device according to claim 1, wherein the controller is further configured to determine that the defined condition is satisfied, based on at least one of a first period during which the value of the temperature sensor increases or a second period during which the value of the temperature sensor remains constant.

3. The aerosol-generating device according to claim 1, wherein the controller is further configured to determine that the defined condition is satisfied, based on a period during which the battery is supplying the power to the heater.

4. The aerosol-generating device according to claim 1, wherein the controller is further configured to determine the compensation of the value of the temperature sensor by subtracting a defined compensation value from the value of the temperature sensor.

5. The aerosol-generating device according to claim 1, wherein the controller is further configured to determine whether to initiate charging of the battery based on the determined temperature of the battery, in response to receiving a request for initiating charging of the battery.

6. The aerosol-generating device according to claim 5, further comprising:
a power terminal coupled to a side of a housing,
wherein the controller is further configured to determine that the request for initiating charging of the battery is in response to a coupling of a power line and the power terminal.

7. The aerosol-generating device according to claim 1, wherein the controller is further configured to stop the charging of the battery, based on the determined temperature of the battery being equal to or higher than a defined first temperature.

8. The aerosol-generating device according to claim 7, wherein the controller is further configured to interrupt supply of power to components included in the aerosol-generating device based on the determined temperature of the battery being equal to or higher than a second temperature, higher than the first temperature.

9. The aerosol-generating device according to claim 1, wherein the temperature sensor comprises a thermistor coupled to a printed circuit board disposed adjacent to the battery.

10. A method for operating an aerosol-generating device having a temperature sensor and a battery, the method comprising:
monitoring a value of the temperature sensor, after charging of the battery has stopped;
determining the value of the temperature sensor to be a determined temperature of the battery, based on the monitored value of the temperature sensor satisfying a defined condition related to the battery; and
determining compensation of the value of the temperature sensor to be the determined temperature of the battery, based on the monitored value of the temperature sensor not satisfying the defined condition related to the battery.

11. An aerosol-generating device comprising:
a heater configured to heat an aerosol-generating substance;
a battery configured to supply power to the heater to enable the heater to heat the aerosol-generating substance;
a temperature sensor disposed relative to the battery; and
a controller configured to:
identify a value of the temperature sensor over a time period, after stopping of charging of the battery;
determine that the identified value of the temperature sensor corresponds to a temperature of the battery, based on the identified value of the temperature sensor over the time period satisfying a condition; and
determine the temperature of the battery as being a combination of the identified value of the temperature sensor and a compensation value, based on the identified value of the temperature sensor over the time period not satisfying the condition.

12. The aerosol-generating device according to claim 11, wherein the controller is further configured to determine whether to initiate charging of the battery based on the temperature of the battery, in response to receiving a request for initiating charging of the battery.

13. The aerosol-generating device according to claim 11, wherein the controller is further configured to:
stop the charging of the battery, based on the temperature of the battery being equal to or higher than a first temperature; and
interrupt supply of power to components included in the aerosol-generating device, based on the temperature of the battery being equal to or higher than a second temperature, higher than the first temperature.
